(19) United States
(12) Patent Application Publication
(10) Pub. No.: US 2002/0010107 A1
(43) Pub. Date: Jan. 24, 2002

(54) Perfume composition for laundry detergent

(75) Inventors: Kunihide Hoshino, Kanagawa (JP); Kazutoshi Sakurai, Kanagawa (JP)

Correspondence Address: SUGHRUE, MION, ZINN,, MACPEAK & SEAS, PLLC, 2100 Pennsylvania Avenue, N.W., Washington, DC, 20037-3213, US

(73) Assignee: TAKASAGO INTERNATIONAL CORPORATION

(21) Appl. No.: 09/866,606

(22) Filed: May 30, 2001

(30) Foreign Application Priority Data
May 30, 2000 (JP) P2000-160246

(51) Int. Cl. C11D 3/50; C11D 3/37

(52) U.S. Cl. 510/101; 510/475

(57) ABSTRACT

The present invention provides a laundry detergent composition capable of retaining an added perfume in a stable manner and exhibiting a sustained laundry odor masking effect. Thus, the invention is a perfume composition for a laundry detergent having a perfume and a hydrophobic polymer and the perfume composition for a laundry detergent further having a cationic surfactant.

### BACKGROUND OF THE INVENTION

1. Field of the Invention

The present invention relates to a perfume composition for a laundry detergent, more particularly, to a perfume composition for a laundry detergent having an excellent odor masking effect without allowing a perfume component which has been added to the laundry detergent composition to readily evaporate during laundering or to be lost as a result of migration into an aqueous phase (any water used during the laundering process; hereafter simply “aqueous phase”).

2. Description of the Background Art

A laundry detergent composition is usually supplemented with a perfume for the purpose of masking odor attributable to a starting component of the detergent itself or to give a satisfactory smell on use to a consumer.

In such case, a perfume, when added alone, readily undergoes evaporation and/or migration into an aqueous phase upon laundering, migration resulting in a loss of the perfume upon drainage of the laundering device, typically a washer. As a means to prevent the loss of perfume during laundering, inclusion of a perfume in cyclodextrin has been proposed for the purpose of improving a perfume-lasting effect (JP-A-1 -190796,1-193397).

A substitute for cyclodextrin has also been investigated extensively, and an attempt was made to promote perfume-sustaining performance by adding a perfume composition comprising a perfume and an aqueous polymer to a laundry detergent composition (JP-A-1 1-139923).

However, even when a perfume is added in a manner as described above, the perfume is released and migrates into the aqueous phase and then is lost, since a hydrophilic polymer dissolves in water. Accordingly, any odor generated from the washed clothes cannot be sufficiently masked.

### SUMMARY OF THE INVENTION

An object of the invention is to provide a perfume composition for a laundry detergent which is capable of retaining the perfume, once the perfume composition is added to the laundry detergent, in the laundry detergent in a stable manner so that the perfume will exhibit an odor masking effect over a prolonged period of time during laundering and after drying.

The present inventors made an effort to develop a perfume composition capable of achieving the object described above and finally discovered that the problems described above can be solved by combining a perfume with a hydrophobic polymer, thus reaching the present invention. Moreover, the present inventors also discovered that the further addition of a cationic surfactant to the perfume composition not only allows the perfume to migrate into items being washed (clothes), thereby prolonging the odor masking effect o f the perfume, but also allowing the antibacterial effect of an antibacterial perfume to be exerted.

Thus, the first aspect of the invention relates to a perfume composition for a laundry detergent comprising a perfume and a hydrophobic polymer.

The second aspect of the invention relates to a perfume composition for a laundry detergent according to the first aspect of the invention wherein 1 part by weight of the perfume is combined with 0.001 to 0.5 parts by weight of the hydrophobic polymer.

The third aspect of the invention relates to a perfume composition for a laundry detergent according to the first aspect of the invention wherein the hydrophobic polymer is one or more hydrophobic polymers selected from the group consisting of a polystyrene, ethyl cellulose, a poly(α-methylstyrene), a poly(3-hydroxybutyric acid) and a polynorbornene.

The fourth aspect of the invention relates to a perfume composition for a laundry detergent according to the first aspect of the invention wherein the hydrophobic polymer is a polystyrene or ethyl cellulose.

The fifth aspect of the invention relates to a perfume composition for a laundry detergent according to any of the first to fourth aspects of the invention further comprising a cationic surfactant.

The sixth aspect of the invention relates to a perfume composition for a laundry detergent according to the fifth aspect of the invention wherein the cationic surfactant is dimethyidistearylammonium chloride.

The seventh aspect of the invention relates to a method for producing a laundry detergent composition having a high odor masking effect wherein a perfume is added to the laundry detergent composition together with a hydrophobic polymer or with a hydrophobic polymer and a cationic surfactant.

### DESCRIPTION OF THE PREFERRED EMBODIMENTS

The perfume employed in the invention is not limited particularly, and any of various perfumes can be employed alone or in combination. A natural perfume used (natural essential oils) may, for example, be ylang-ylang oil, elemi oil, galbanum oil, clary sage oil, sandalwood oil, citronella oil, jasmine oil, cedarwood oil, geranium oil, patchouli oil, peru balsam oil, lavender oil, lemon grass oil and rose oil.

A synthetic perfume used may, for example, be a hydrocarbon(s) such as pinene, limonene, caryophyllene and longifolene, an alcohol(s) such as cis-3-hexenol, L EVOSANDOL® (TAKASAGO I NTERNATIONAL C ORPORATION), p -t-butylcyclohexanol, citronellol, geraniol, nerol, linalool, dihydrolinalool, tetrahydrolinalool, dihydromyrcenol, tetrahydromyrcenol, menthol, terpineol, borneol, isoborneol, isocamphyl cyclohexanol, farnesol, cedrol, benzyl alcohol, α-phenyl ethyl alcohol, β-phenyl e thyl a Icohol, c innamic a Icohol, a mylcinnamic a Icohol, t hymol, eugenol and isoeugenol, an ether(s) such as estragol, β-naphthol methyl ether, β-naphthol ethylether, diphenyloxide, cedrol methylether, isoamyl phenyethyl ether, Ambroxan® (Henkel KGaA), Grisalva® (International Flavors & Fragrances) and rose oxide, an aldehyde(s) such as undecanal, dodecanal, 2-methyl undecanal, 10-undecenal, trimethylundecenal, citronellal, citral, hydroxy citronellal, dimethyl tetrahydro-benzaldehyde, Myrac aldehyde® (International Flavors & Fragrances), KOVANOL® (TAKASAGO INTERNATIONAL CORPORATION), Vernaldehyde® (Givaudan-Roure SA), benzaldehyde, cyclamen aldehyde, SUZARAL® (TAKASAGO INTERNATIONAL CORPORATION), Lilial® (Givaudan-Roure SA), cinnamic aldehyde, methyl cinnamic aldehyde, amyl cinnamic aldehyde, hexyl cinnamic aldehyde, vanillin, ethyl vanillin, heliotropine and HELIOBOUQUET® (TAKASAGO INTERNATIONAL CORPORATION), a ketone(s) such as cis-jasmone, dihydrojasmone, CYCLOTENE, DAMASCENONE, DAMASCONE, ionone, methyl ionone, irone, Cashmeran® (International Flavors & Fragrances), iso-E-super® (International Flavors & Fragrances), carvone, menthone, acetyl cedrene, isolongifolanone, raspberry ketone and benzophenone, an ester(s) such as γ-undecalactone, coumarin, linalyl formate, citronellyl formate, linalyl acetate, citronellyl acetate, geranyl acetate, terpinyl acetate, cedryl acetate, p-t-butylcyclohexyl acetate, 2-t-butyl cyclohexyl acetate, tricyclodecenyl acetate, benzyl acetate, phenylethyl acetate, styrallyl acetate, rosephenone, dimethyl benzyl carbinyl acetate, JASMAL® (International Flavors & Fragrances), benzyl benzoate, benzyl salicylate, methyl atrarate, methyl anthranilate, ethyl anthranilate and Aurantiol® (Givaudan-Roure SA), a musk(s) such as cyclopentadecanone, cyclohexadecenone, cyclopentadecanolide, 10-oxahexadecanolide, ethylene brassylate, ethylene dodecanedioate, celestolide® (International Flavors & Fragrances), Tonalid® (Polak's Furutal Works BV) and Galaxolide® (International Flavors & Fragrances).

A perfume with antibacterial activity may, for example, be clary sage oil, clove oil, labdanum resinoid, lemon grass oil, oakmoss absolute, sandalwood oil, thyme oil, vetiver oil, 1-dodecanol, LEVOSANDOL® (TAKASAGO INTERNATIONAL CORPORATION), cinnamic aldehyde, citral, citronellol, cyclamen aldehyde, eugenol, thymol, farnesol, geraniol, hinokitiol, isobutylquinoline, isoeugenol, methyl atrarate, α-decalactone and α-undecalactone.

The hydrophobic polymer may be any of various hydrophobic polymers, which may be employed alone or in combination. The hydrophobic polymer employed in the invention preferably has a high molecular weight in view of the desired perfume-sustaining effect. Examples of hydrophobic polymers which can be employed in the invention are listed below.

A polyacrylate-based hydrophobic polymer may, for example, be poly(n-butyl acrylate), poly(t-butyl acrylate), poly(methyl acrylate), poly(ethyl acrylate) and/or poly(2-ethylhexyl acrylate).

A polydiene-based hydrophobic polymer may, for example, be polybutadiene and/or polyisoprene.

A polymethacylate-based hydrophobic polymer may, for example, be poly(n-butyl methacrylate), poly(t-butyl methacrylate), poly(methyl methacrylate), poly(ethyl methacrylate), poly(n-nonyl methacrylate) and/or poly(octadecyl methacrylate).

In addition, a cellulose derivative such as methyl cellulose, trimethyl cellulose, ethyl cellulose, benzyl cellulose, cellulose acetate, cellulose triacetate, cellulose propionate and cellulose butyrate, poly(3-hydroxybutyrate) and/or polynorbornene is also useful. An ethyl cellulose with a high ethoxyl group content (for example, 48 to 50 %), is especially useful.

A polystyrene-based hydrophobic polymer may, for example, be poly(4-bromostyrene), poly(4-t-butylstyrene), poly(4-chlorostyrene), poly(α-methylstyrene), poly(4-methylstyrene), poly(4-methoxystyrene) and/or polystyrene.

A poly(vinylpyridine)-based hydrophobic polymer may, for example, be poly(2-vinylpyridine) and/or poly(4-vi nylpyridine).

Other useful hydrophobic polymers are, for example, polyethylene, polypropylene, polycaprolactone, polybutene, polyisobutylene, polyethylene terephthalate, polybutylene terephthalate, polyvinyl chloride, polyvinylidene chloride, polyvinyl acetate, polyvinyl methylether, polyvinyl ethylether, polyethylene oxide, polypropylene oxide, polyphenylene ether, polylactic acid, polydimethylsiloxane, polyethyleneimine, polyterpene, poly(N-vinylcarbazole), poly(2-vinylnaphthalene), polyvinylbenzyl chloride and poly(9-vinylanthracene).

Hydrophobic copolymers may aIso be used as the hydrophobic polymer, alone or in combination with one or more other hydrophobic copolymers and/or with one or more hydrophobic homopolymers. Such a copolymer may, for example, be poly(butadiene-dimethylsiloxane), poly(butadiene-4-vinylpyridine), poly(n-butyl-acrylate-methylmethacrylate), poly(t-butylmethacrylate-2-vinylpyridine), poly(isoprene-methylacrylate), poly(isoprene-2-vinylpyridine), poly(methylmethacrylate-t-butylmethacrylate), poly(methylmethacrylate-t-butylacrylate), poly(styrene-acrylonitrile), poly(styrene-divinylbenzene), poly(styrene-vinylacetate), poly(styrene-vinylpyrrolidone), poly(styrene-methylmethacrylate), poly(styrene-t-butylmethacrylate), poly(styrene-n-butylacrylate), poly(styrene-t-butylacrylate), poly(styrene-butadiene), poly(styrene-isoprene), poly(styrene-4-vinylpyridine), poly(styrene-2-vinylpyridine), poly(styrene-t-butylstyrene), poly(styrene-p-chloromethylstyrene), polystyrene-dimethylsiloxane), poly(2-vinylpyridine-methylmethacrylate), poly(ethylene oxide-styrene), poly(methylmethacrylate-methacrylic acid), poly(styrene-acrylic acid), poly(styrene-butylene), poly(styrene-ethylene acrylate), poly(styrene-acrylic acid-methyl methacrylate), poly(styrene-butadiene methyl methacrylate), poly(styrene-t-butylacrylate methyl methacrylate), poly(styrene-2-vinylpyridine-ethylene oxide), poly(acrylonitrile-butadiene-styrene) and poly(styrene-methylstyrene-indene).

For a suitable ratio of perfume and one or more hydrophobic polymers (homopolymers and/or copolymers) in a perfume composition, 1 part by weight of the perfume is combined with 0.001 to 0.5 parts by weight of the one or more hydrophobic polymers, preferably 0.05 to 0.2 parts by weight.

The method of combining one or more hydrophobic polymers and one or more perfumes is not subject to any particular limitations, and may be accomplished merely by mixing the one or more perfumes and the one or more hydrophobic polymers at room temperature, or by dissolving these components with heating to form a uniform mixture.

When a perfume composition according to the invention is added to a laundry detergent composition, it may be added in an amount which may vary, depending on the purpose of use, and which usually ranges from 0.001 to 0.02 parts by weight of the perfume composition per 1 part by weight of the detergent.

### EXAMPLES

The present invention is now further illustrated by the following Examples, which are not intended to restrict the invention.

An example of the composition of a perfume is shown in Table 1. This was used in the working Examples.

TABLE 1

| Formulated perfume | Part by weight |
|---|---|
| Ambroxan ® | 15 |
| Benzyl acetate | 25 |
| Citronellal | 50 |
| Coumarin | 60 |
| Tricyclodecenyl acetate | 80 |
| Cyclamen aldehyde | 20 |
| Dihydromyrcenol | 80 |
| Diphenyloxide | 20 |
| Geraniol | 50 |
| Geranylnitrile | 10 |
| Hexylcinnamicaldehyde | 155 |
| Limonene | 20 |
| Linalool | 50 |
| Nerol | 20 |
| Nopyl acetate | 20 |
| Pearlide ® (KAO Co., Ltd.) | 80 |
| Rose oxide | 5 |
| Tetrahydrolinalool | 10 |
| Tetrahydromyrcenol | 10 |
| Tonalid ® (Polak's Furutal Works BV) | 50 |
| 2-t-Butylcyclohexyl acetate | 70 |
| p-t-Butylcyclohexyl acetate | 100 |
| | 1000 |

(Experiment and residual perfume detection)

A perfume in combination with a hydrophobic polymer was added to form a product of the invention, while a perfume alone or a hydrophobic polymer alone was added to form two comparative products. Using both types of products, the products to be tested were added to a powdered detergent base, and then towels were washed under similar conditions with the products to be tested. Thereafter, perfume components evaporating from the towels which were being dried under similar conditions were analyzed by gas chromatography. The total of all the perfume components detected was compared between the product of the invention and the comparative product which contained the perfume.

The % increase in the level of the detected perfume of the product of the invention based on the comparative product was calculated as shown below. % Increase=100×((inventive perfume level)-(comparative perfume level))/(comparative perfume level)

Instruments

GC Condition

GC: HP6890 (Hewlett Packard)

Column: DB-WAX (J&W), 30 m in length, 0.25 mm in inner diameter, 0.15 μm in thickness

Injection temperature: 250° C.

Detection temperature: 250° C.

Initial temperature: 60° C.

Heating rate: 3.7° C./min

Final temperature: 210° C.

### Example 1:

The three perfume compositions given in Table 2 shown below (unit: % by weight) were prepared and a face towel (weighing 23 g) was washed in a conventional washer (hereafter the same) w ith a laundry detergent composition (detergent) (10 g) to which each perfume composition had been added in an amount of 1% (based on detergent weight) and 1 L of water for 10 minutes. Thereafter the towel was rinsed with 1 L of water and dehydrated (squeezed to remove water; hereafter the same). The towel was then dried at 25° C. and 50 % humidity for 6 hours, and then the perfume components as the volatiles from the dried towel were analyzed by gas chromatography.

TABLE 2

| | Inventive | Comparative | Comparative |
|---|---|---|---|
| Composition | Composition 1 | Composition 1 | Composition 2 |
| Polynorbornene*¹ | 20 | — | — |
| Polyvinyl- | — | — | 20 |
| pyrrolidone*² | | | |
| Perfume (Table 1) | 80 | 100 | 80 |

*¹Product of CdF (Imported by NIPPON ZEON)
*²Product of YUKA BERDISH (Marketed by MITSUBISHI SHOJI)

The results are shown in Table 3. As is evident from Table 3, Inventive Composition 1 supplemented with a hydrophobic polymer exhibited an elevated total detected level of perfume components, representing a large % increase.

TABLE 3

| | Inventive | Comparative | Comparative |
|---|---|---|---|
| Composition | Composition 1 | Composition 1 | Composition 2 |
| Total detected perfume | 1566 | 470 | 531 |
| level (pA) | | | |
| % Increase | 233 | — | 13 |

*Percent based on Comparative Composition 1

### Example 2:

The perfume composition shown in Table 4 (unit: % by weight) was prepared and a face towel (weighing 23 g) was washed with a detergent (10 g) which had added thereto the perfume composition at 1 % and 1 L of water for 10 minutes. Thereafter the towel was rinsed with 1 L of water and dehydrated. The towel was then dried at 20° C. and 50 % humidity for 6 hours, and then the perfume components as the volatiles from the dried towel were analyzed by gas chromatography.

TABLE 4

| | Inventive | Inventive | Inventive | Inventive | Comparative |
|---|---|---|---|---|---|
| | Composition | Composition | Composition | Composition | Composition |
| Composition | 2 | 3 | 4 | 5 | 3 |
| Polystyrene* | 10 | — | — | — | — |
| (MW: 1,880,000) | | | | | |
| Polystyrene | — | 10 | — | — | — |
| (MW: 550,000) | | | | | |
| Polystyrene | — | — | 10 | — | — |
| (MW: 210,000) | | | | | |
| Polystyrene | — | — | — | 10 | — |
| (MW: 20,000) | | | | | |
| Perfume | 90 | 90 | 90 | 90 | 100 |
| (Table 1 | | | | | |

*Polystyrene (ASAHI KASEI or MITSUBISHI KAGAKU)

The results are shown in Table 5. All of the tested compositions exhibited a substantial increase in the total detected level of perfume components. An elevated % increase was especially exhibited by Inventive Composition 2, which was supplemented with a hydrophobic polymer having a higher molecular weight.

TABLE 5

| | Inventive | Inventive | Inventive | Inventive | Comparative |
|---|---|---|---|---|---|
| | Composition | Composition | Composition | Composition | Composition |
| Composition | 2 | 3 | 4 | 5 | 3 |
| Total detected | 1126 | 129 | 38 | 26 | 11 |
| perfume level (pA) | | | | | |
| % Increase | 10136 | 1072 | 245 | 136 | — |

*Percent based on Comparative Composition 3

### Example 3:

The perfume composition shown in Table 6 (unit: % by weight) was prepared and a face towel (weighing 23 g) was washed with a detergent (10 g) to which the perfume composition shown had been added in an amount of 1% (based on detergent weight) and 1 L of water for 10 minutes. Thereafter the towel was rinsed with 1 L of water and dehydrated. The towel was then dried at 20° C. and 50 % humidity for 2 hours, and then the perfume components as the volatiles from the dried towel were analyzed by gas chromatography.

TABLE 6

| | Inventive | Inventive | Comparative |
|---|---|---|---|
| Composition | Composition 6 | Composition 7 | Composition 4 |
| Polystyrene* | 10 | 5 | |
| (MW: 550,000) | | | |
| Perfume | 90 | 95 | 100 |
| (Table 1) | | | |

*Polystyrene (ASAHI KASEI or MITSUBISHI KAGAKU)

The results are shown in Table 7. An elevated total detected level of the perfume components was especially exhibited by Inventive Composition 6 to which had been added an increased amount of the hydrophobic polymer, with a substantial % increase.

TABLE 7

| | Inventive | Inventive | Comparative |
|---|---|---|---|
| | Composition 6 | Composition 7 | Composition 4 |
| Total detected | 384 | 58 | 44 |
| perfume level (pA) | | | |
| % Increase | 773 | 32 | — |

*Percent based on Comparative Composition 4

### Example 4

The perfume composition shown in Table 8 (unit: % by weight) was prepared and a face towel (weighing 23 g) was washed with a detergent (10 g) to which had been added the perfume composition shown in an amount of 1% (based on detergent weight) and 1 L of water for 10 minutes. Thereafter the towel was rinsed with 1 L of water and dehydrated. The towel was then dried at 20° C. and 50 % humidity for 2 hours, and then the perfume components as the volatiles from the dried towel were analyzed by gas chromatography.

TABLE 8

| | Inventive | Inventive | Comparative |
|---|---|---|---|
| | Composition | Composition | Composition |
| | 8 | 9 | 5 |
| Ethyl cellulose*¹ | 5 | 5 | |
| Distearydimethylammonium | 2 | 0.5 | |
| chloride*² | | | |
| Perfume (Table 1) | 93 | 94.5 | 100 |

*¹Hercules (imported by NISSHO IWAI)
*²SANYO KASEI KOGYO

The results are shown in Table 9. Inventive Compositions 8 and 9 each of which had a hydrophobic polymer and a cationic surfactant added thereto exhibited a large % increase.

TABLE 9

| | Inventive | Inventive | Comparative |
|---|---|---|---|
| | Composition 8 | Composition 9 | Composition 5 |
| Total detected | 788 | 312 | 44 |
| perfume level (pA) | | | |
| % Increase | 1691 | 609 | — |

*Percent based on Comparative Composition 5

As described above, the present invention provides a laundry detergent composition capable of retaining a perfume added thereto in a stable manner without allowing the perfume to migrate into an aqueous phase during laundering, thereby exhibiting a sustained masking effect for a prolonged period of time.

While a perfume composition for a laundry detergent according to the present invention basically involves the use of a perfume and a hydrophobic polymer as described above, the perfume composition may also further be supplemented with a cationic surfactant to further improve the perfume-sustaining effect and to allow the perfume, once it is partially released from the laundry detergent, to migrate into and be immobilized on items being washed (clothes). In addition, an antibacterially active polymer, when employed, may impart items washed with the laundry detergent with an antibacterial effect.

For this purpose, the cationic surfactant which can be employed may be a quaternary ammonium salt and/or an amine derivative preferably having a hydrophobic side chain, such as, for example, distearyldimethylammonium chloride, stearyltrimethylammonium chloride, cetyltrimethylammonium chloride, lauryltrimethyl-ammonium chloride, behenyltrimethylammonium chloride, stearyldimethylbenzylammonium chloride and myristyidimethyl-benzylammonium chloride. A suitable amount of a cationic surfactant to be added is 0.1 to 100 % by weight based on the weight of the perfume composition.

The method of addition of the cationic surfactant to the perfume composition is not subjected to any particular limitations, and may be accomplished merely by mixing three components, i.e., the perfume, the hydrophobic polymer and the cationic surfactant.

Another embodiment of the present invention provides a method for producing a laundry detergent composition having a high masking effect wherein a perfume is added to the laundry detergent composition together with a hydrophobic polymer or together with a hydrophobic polymer and a cationic surfactant.

By using the laundry detergent composition of the present invention, perfume is prevented from evaporation from the laundry detergent composition and prevented from migrating into an aqueous phase (any water used for the laundering or washing) which results in a loss of perfume upon drainage or disposal of any such water, thus improving the masking effect of the perfume during laundering and after drying.

While the invention has been described in detail and with reference to specific embodiments thereof, it will be apparent to one skilled in the art that various changes and modifications can be made therein without departing from the spirit and scope thereof.

What is claimed is:

1. A perfume composition for a laundry detergent comprising a perfume and a hydrophobic polymer.

2. A perfume composition for a laundry detergent according to claim 1 wherein 1 part by weight of the perfume is combined with 0.001 to 0.5 parts by weight of the hydrophobic polymer.

3. A perfume composition for a laundry detergent according to claim 1 wherein the hydrophobic polymer is one or more hydrophobic polymers selected from the group consisting of a polystyrene, ethyl cellulose, a poly(α-methylstyrene), a poly(3-hydroxybutyric acid) and a polynorbornene.

4. A perfume composition for a laundry detergent according to claim 1 wherein the hydrophobic polymer is a polystyrene or ethyl cellulose.

5. A perfume composition for a laundry detergent according to any one of claims 1 to 4 further comprising a cationic surfactant.

6. A perfume composition for a laundry detergent according to claim 5 wherein the cationic surfactant is di methyldistearylammoni um chloride.

7. A method for producing a laundry detergent composition having a high masking effect wherein a perfume is added to the laundry detergent composition together with a hydrophobic polymer or with a hydrophobic polymer and a cationic surfactant.
